(19) United States
(12) Patent Application Publication
(10) Pub. No.: US 2005/0204174 A1
(43) Pub. Date: Sep. 15, 2005

(54) Password protection mechanism

(75) Inventors: Cary Lee Bates, Rochester, MN (US); Paul W. Buenger, Eau Claire, WI (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/798,909

(22) Filed: Mar. 11, 2004

(51) Int. Cl. H04L 9/00

(52) U.S. Cl. 713/202; 726/7

(57) ABSTRACT

A method, apparatus, system, and signal-bearing medium that in an embodiment determine whether a password is restricted to a set of pages, deny submission of the password outside the set of pages if the password is restricted, and allow submission of the password outside the set of pages if the password is not restricted. In various embodiments, the set of pages includes all pages in a domain or only a single page. In various embodiments, restriction of the password may be specified via control information in a page or via a user interface.

### FIELD

An embodiment of the invention generally relates to computers. In particular, an embodiment of the invention generally relates to a password protection mechanism.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

Years ago, computers were isolated devices that did not communicate with each other. But, today computers are often connected in networks, such as the Internet or World Wide Web, and a user at one computer, often called a client, may wish to access information at multiple other computers, often called servers, via a network. Many applications on these servers require a password before allowing access, in order to safeguard confidential information and to prevent the introduction of harmful code, such as viruses, worms, and Trojan horses. For example, users might need passwords to power on their computer and to access business email, personal email, online banking, mortgage accounts, news services, classified ads, or online shopping. All of these passwords can add up quickly, and it is quite common for a user to have tens or even hundreds of passwords, which overloads the user's ability to remember all of them.

In an attempt to manage their many passwords, exasperated users sometimes resort to tactics that may unintentionally undermine security. For example, some users might write all of their passwords on a sheet of paper left in their desk drawer, which is easily stolen or viewed by unauthorized persons. Also, users might use identical passwords for multiple applications, which makes security at one application site only as good as the security at all other applications. For example, if a user uses the same password at work as he uses to buy paintbrushes at an online painting supply store, no matter how good the security is at the user's workplace, it can be compromised by stealing passwords from the painting supply store, which might have a much lower level of security. Also, even a user who has studiously memorized a long list of passwords still may not be able to remember which password goes with which web site. Thus, a user might enter several passwords in succession at a current web site that are valid for another site but not valid for the current site. This can result in major security problems if an unscrupulous website operator sets up a website to collect these passwords.

One current solution to the problems is a single tool that requires a single password to gain access to a file that contains multiple other passwords. Such tools are similar to the piece of paper in the desk drawer solution, except that a password is required for access. These tools are often used where security is not a major concern and the main reason for passwords is that different applications have different rules for what constitutes a valid password. Many businesses and employers discourage the use of such tools because they allow a single password to gain access to all applications. Also, these tools usually store the passwords in a file on the user's client computer, which may be more prone to a security breach than the server computer containing the individual applications.

Without a better way to manage the multitude of passwords that users must deal with, computer security will continue to be a problem.

### SUMMARY

A method, apparatus, system, and signal-bearing medium are provided that in an embodiment determine whether a password is restricted to a set of pages, deny submission of the password outside the set of pages if the password is restricted, and allow submission of the password outside the set of pages if the password is not restricted. In various embodiments, the set of pages includes all pages in a domain or only a single page. In various embodiments, restriction of the password may be specified via control information in a page or via a user interface.

### BRIEF DESCRIPTION OF THE DRAWING

FIG. 1 depicts a block diagram of an example system for implementing an embodiment of the invention.

FIG. 2 depicts a pictorial representation of an example user interface, according to an embodiment of the invention.

FIG. 3A depicts a block diagram of an example password list data structure, according to an embodiment of the invention.

FIG. 3B depicts a block diagram of an example domain list data structure, according to an embodiment of the invention.

FIG. 4A depicts a block diagram of an example page that includes a meta tag with a password restriction, according to an embodiment of the invention.

FIG. 4B depicts a block diagram of another example page that includes a meta tag with a password restriction, according to an embodiment of the invention.

FIG. 5 depicts a flowchart of example processing for handling pages and forms, according to an embodiment of the invention.

FIG. 6A depicts a flowchart of example processing for submitting a form, according to an embodiment of the invention.

FIG. 6B depicts a flowchart of further example processing for submitting a form, according to an embodiment of the invention.

### DETAILED DESCRIPTION

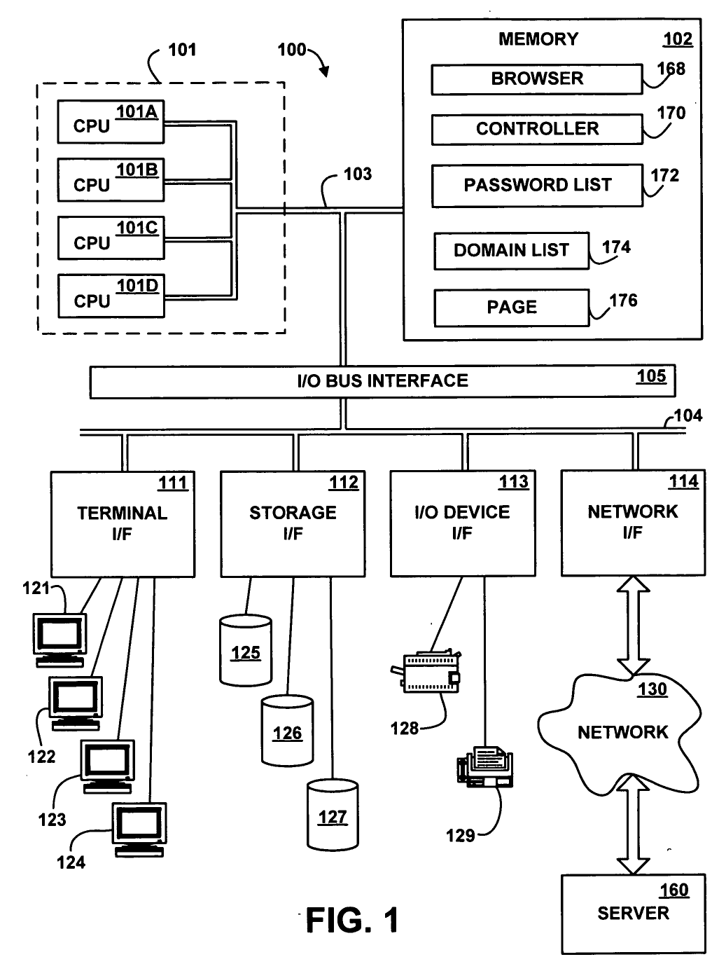

Referring to the Drawing, wherein like numbers denote like parts throughout the several views, FIG. 1 depicts a high-level block diagram representation of a computer system 100 connected via a network 130 to a server 160, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a browser 168, a controller 170, a password list 172, a domain list 174, and a page 176. Although the browser 168, the controller 170, the password list 172, the domain list 174, and the page 176 are all illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the browser 168, the controller 170, the password list 172, the domain list 174, and the page 176 are illustrated as residing in the memory 102, these elements are not necessarily all completely contained in the same storage device at the same time.

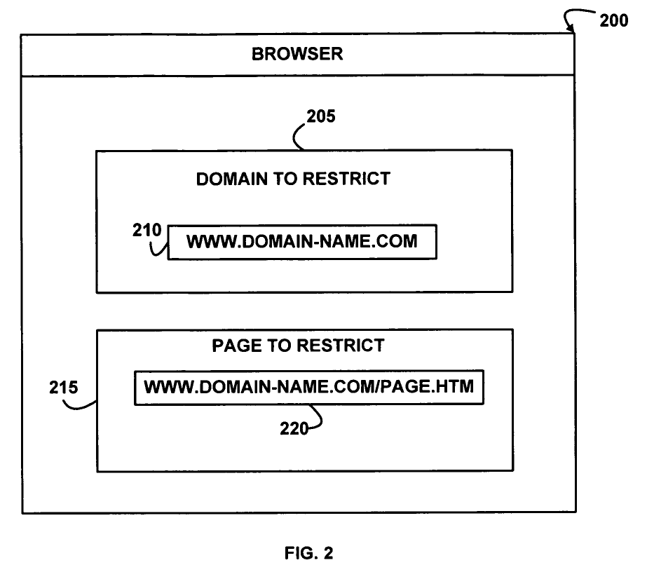

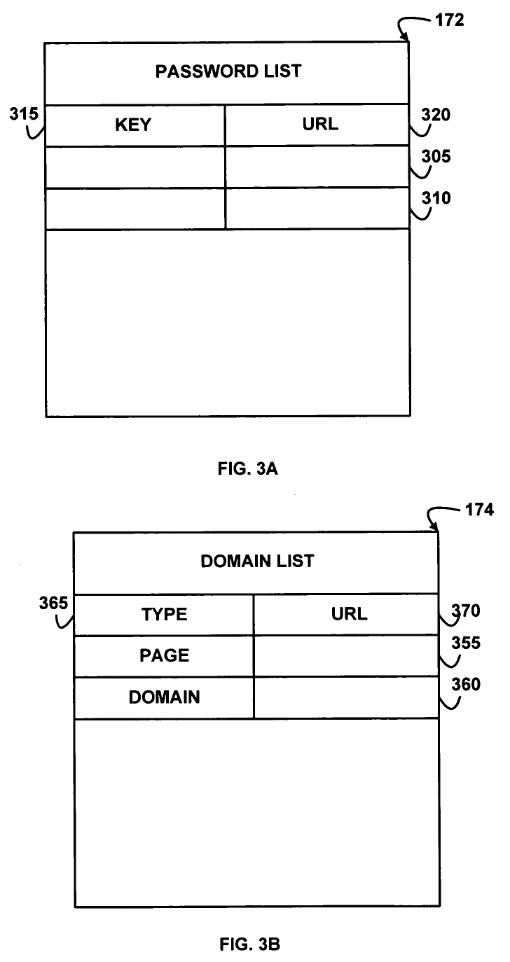

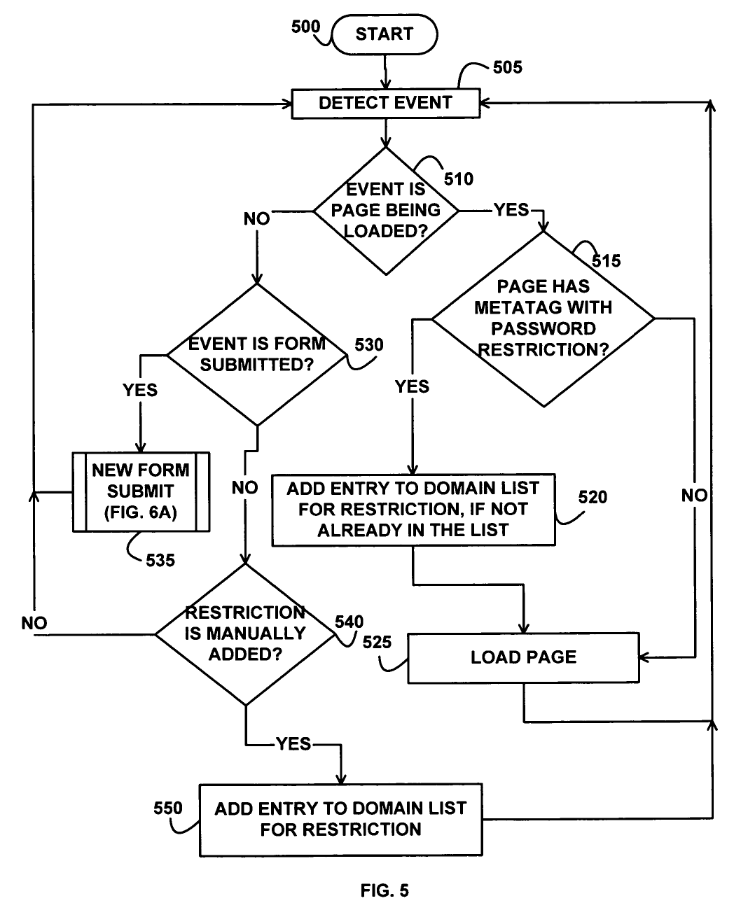

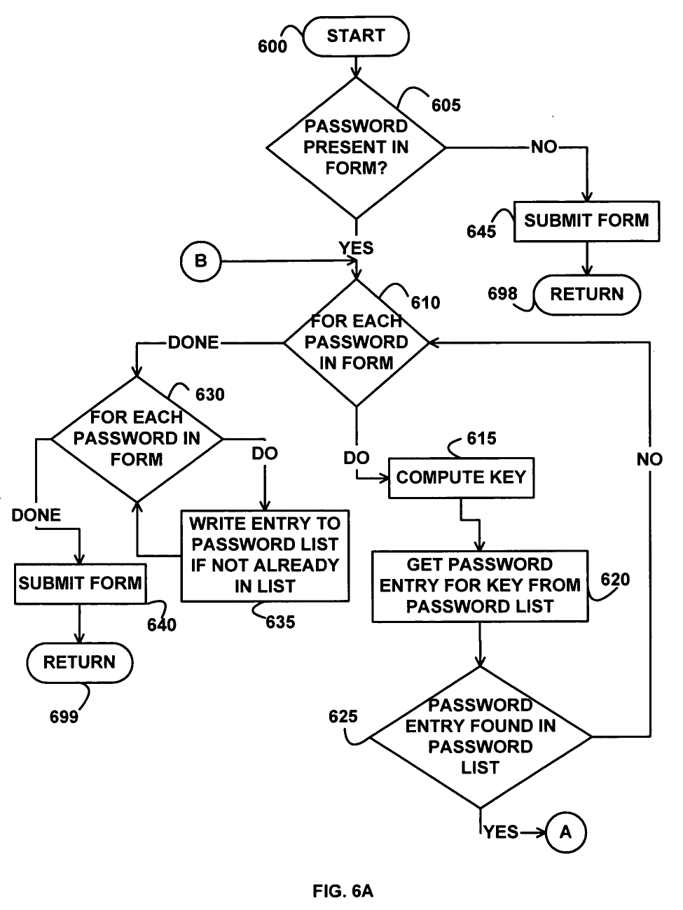

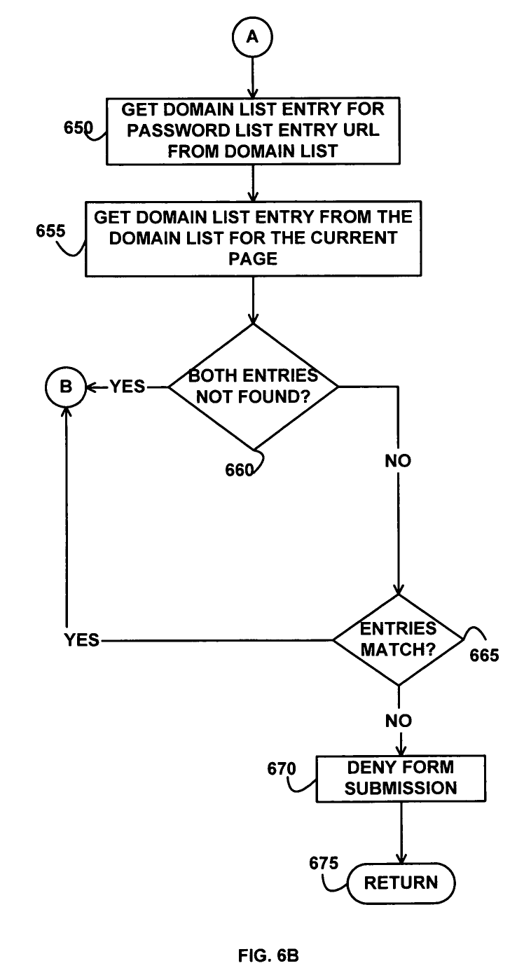

The browser 168 retrieves the page 176 from the server 160 and interprets the page 176 for display. In an embodiment, the controller 170 is a plug-in to the browser 168. In another embodiment, the controller 170 performs the functions of the browser 168, and the browser 168 is not present or not used. In an embodiment, the controller 170 includes instructions capable of executing on the processor 101 or statements capable of being interpreted by instructions executing on the processor 101 to present the user interface as further described below with reference to FIG. 2, to manipulate the data structures as further described below with reference to FIGS. 3A and 3B, and to perform the functions as further described below with reference to FIGS. 5, 6A, and 6B. In another embodiment, the controller 170 may be implemented in microcode. In yet another embodiment, the controller 170 may be implemented in hardware via logic gates and/or other appropriate hardware techniques, in lieu of or in addition to a processor-based system.

The password list 172 and the domain list 174 are data structures manipulated by the controller 170. The password list 172 is further described below with reference to FIG. 3A. The domain list 174 is further described below with reference to FIG. 3B.

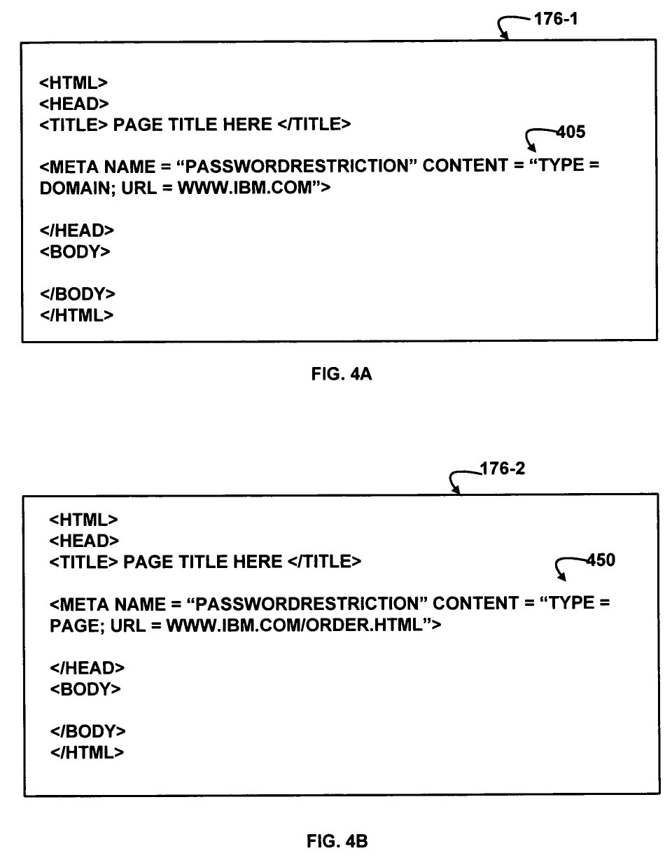

The page 176 is a file retrieved by the browser 168 or the controller 170 from the server 160. The page 176 may include data and control information. In various embodiments the page 176 is encoded in HTML (Hypertext Markup Language), XML (Extensible Markup Language), or any other appropriate format. Examples of the page 176 are further described below with reference to FIGS. 4A and 4B.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100 and the server 160. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

It should be understood that FIG. 1 is intended to depict the representative major components of the computer system 100, the network 130, and the server 160 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a pictorial representation of an example user interface 200, according to an embodiment of the invention. The browser 168 or the controller 170 displays the example user interface 200 on one of the terminals 121, 122, 123, or 124. The example user interface 200 includes a domain to restrict dialog 205, which allows the user to specify a URL (Universal Resource Locator) 210, which indicates the address of the domain for which the controller 170 restricts password use, but in other embodiments any appropriate address may be used. The example user interface 200 further includes a page to restrict dialog 215, which allows the user to specify a URL (Universal Resource Locator) 220, which indicates the address of the page for which the controller 170 restricts password use. A web site domain may be organized into a hierarchy of pages. In another embodiment, the dialogs 205 and 215 may be displayed in the alternative. The use of the example user interface 200 is further described below with reference to FIG. 5. The data and user interface elements depicted in FIG. 2 are exemplary only, and in other embodiments any appropriate data and user interface elements may be used.

FIG. 3A depicts a block diagram of an example password list data structure 172, according to an embodiment of the invention. The example password list data structure 172 includes entries 305 and 310, although in other embodiments any number of entries may be present. Each entry includes a key field 315 and a URL field 320. The key field 315 specifies a password that is associated with the URL field 320. In another embodiment, the key field 315 includes a calculated value—e.g., a CRC (Cyclic Redundancy Check), hash value, or checksum—that is based on the password, but in other embodiments any appropriate calculated value or key may be used. The URL field 320 specifies an address of a page or domain for which use of the password indicated in the key 315 is restricted by the controller 170.

FIG. 3B depicts a block diagram of an example domain list data structure 174, according to an embodiment of the invention. The example domain list data structure 174 includes entries 355 and 360, but in other embodiments any number of entries may be present. Each entry includes a type field 365 and a URL field 370. The type field 365 indicates the type of data that is stored in the URL field 370. In the example shown, the entry 355 includes “page” in the type field 365, and the entry 360 includes “domain” in the type field 365. When “page” is included in the type field 365, then the controller 170 restricts passwords only for the page indicated in the associated URL field 370. When “domain” is indicated in the type field 365, then the controller 170 restricts password use for all pages within the domain indicated in the associated URL field 370. The URL field 370 specifies an address of a page or domain for which the controller 170 restricts password use.

FIG. 4A depicts a block diagram of page 176-1, which is an example of the page 176. The example page 176-1 includes a meta tag 405 with a password restriction, according to an embodiment of the invention. The example page 176-1 is encoded in HTML, but in other embodiments any appropriate encoding format may be used. The meta tag 405 indicates that passwords associated with the specified URL are to be restricted and the URL has a type of “domain.”

FIG. 4B depicts a block diagram of page 176-2, which is an example of the page 176. The example page 176-2 includes a meta tag 450 with a password restriction, according to an embodiment of the invention. The example page 176-2 is encoded in HTML, but in other embodiments any appropriate encoding format may be used. The meta tag 450 indicates that passwords associated with the specified URL are to be restricted and the URL is of type page.

FIG. 5 depicts a flowchart of example processing for handling pages and forms, according to an embodiment of the invention. Control begins at block 500. Control then continues to block 505 where the controller 170 receives an event. Control then continues to block 510 where the controller 170 determines whether the event that was previously received at block 505 is a page loaded event. In various embodiments, the page loaded event may occur in response to the page 176 being retrieved from the server 160, the control information in the page 176 being interpreted by the browser 168 or the controller 170, the page 176 being displayed on the terminal 121, 122, 123 or 124, or in response to other appropriate stimulus. If the determination at block 510 is true, then the event previously received is a page being loaded event, so control continues to block 515 where the controller 170 determines whether the loaded page 176 contains a meta tag with a password restriction, such as the example page 176-1 with the meta tag 405 or the example page 176-2 with the meta tag 450.

If the determination at block 515 is true, then the page being loaded does contain a meta tag with a password restriction, so control continues to block 520 where the controller 170 adds an entry to the domain list 174 for the restriction if the restriction is not already contained in the domain list 174. The controller sets the type field 365 in the added entry to indicate a page if the meta tag in the page 176 indicates that passwords are only to be restricted for the current page. The controller sets the type field 365 in the added entry to indicate a domain if the meta tag in the page 176 indicates that passwords are to be restricted for all pages associated with the domain. Control then continues to block 525 where the page loads. Control then returns to block 505, as previously described above.

If the determination at block 515 is false, then the page does not have a meta tag with a password restriction, so control continues to block 525, as previously described above.

If the determination at block 510 is false, then the event does not indicate a page being loaded, so control continues to block 530 where the controller 170 determines whether the received event is a form submitted event. A form is a construct that facilitates the sending of information from the user of the page 176 back to the server 160 that originated the page. One type of information that the user of the page 176 can send to the server 160 via a form is a password. In other embodiments, any appropriate type of construct may be used to send passwords to the server 160.

If the determination at block 530 is true, then the event received is a form submitted event, so control continues to block 535 where the controller 170 processes the form being submitted, as further described below with reference to FIG. 6A. Control then returns to block 505, as previously described above.

If the determination at block 530 is false, then the event received is not a form submitted, so control continues from block 530 to block 540 where the controller 170 determines whether the event was received from the interface 200, as previously described above with reference to FIG. 2. If the determination at block 540 is true, then the event was received from the user interface 200, so control continues to block 550 where the controller 170 adds an entry to the domain list 174. If specified in the user interface 200, the controller 170 sets the domain name specified in the field 210 or 220 into the URL field 370 of the new entry in the domain list 174. The controller 170 further sets the type field 365 of the new entry to indicate either domain or page, as specified by the user. Control then returns to block 505, as previously described above.

If the determination at block 540 is false, then the event was not received from the user interface 200, so control returns from block 540 to block 505, as previously described above.

FIGS. 6A and 6B depict flowcharts of example processing for handling forms, according to an embodiment of the invention. Control begins at block 600. Control then continues to block 605 where the controller 170 determines whether a password is present in the form. If the determination at block 605 is true, then the form does contain a password, so control continues from block 605 to block 610 where the controller 170 performs a loop for each password in the form. So long as there remain unprocessed passwords in the form, control continues from the beginning of the loop at block 610 to block 615. After all of the passwords in the form have been processed, the loop exits from block 610, and control continues from block 610 to block 630.

Thus, for each password in the form, control continues from block 610 to block 615 where the controller 170 computes a key based on the password. In various embodiments, the key may be the password itself, may be a CRC based on the password, or may be any other calculated key, as previously described above with reference to FIG. 3A. Control then continues to block 620 where the controller 170 retrieves the entry from the password list 172 that includes the same key in the key field 315 as the calculated key. Control then continues to block 625 where the controller 170 determines whether the processing of block 620 found an entry in the password list 172. If the determination at block 625 is false, then control returns from block 625 to block 610, as previously described above.

If the determination at block 625 is true, then the password entry was found in the password list 172, so control continues from block 625 to block 650 where the controller 170 retrieves the entry in the domain list 174 that is associated with the URL 320 in the entry in the password list 172 that was previously found at block 620. Control then continues to block 655 where the controller 170 retrieves the entry in the domain list 174 for the current page from which the user has requested a password to be submitted via a form. The controller 170 examines the entries with type “page” first when retrieving the entry for the current page, which in an embodiment is implemented by ordering the entries in the domain list 174 with page in the type field 365 first. But, in other embodiments any appropriate technique for selecting an entry of type page if it exists may be used.

Control then continues to block 660 where the controller 170 determines whether both domain list entries (the domain list entry associated with the current page and the domain list entry associated with the password) were not found. If the determination at block 660 is true, then both entries were not found so control returns from block 660 to the beginning of the loop at block 610, as previously described above.

If the determination at block 660 is false, then at least one domain list entry was found, so control continues from block 660 to block 665 where the controller 170 determines whether the two domain list entries (if both are found) have matching URLs in their URL fields 370. If the domain list entry for the password list entry (previously found at block 650) has a type of domain in the type field 365, the controller 170 truncates the URL 370 in the domain list entry for the current page (previously found at block 655) to its domain before determining whether the URLs match. In this way, the controller 170 restricts password use for all pages within the domain indicated in the URL field 370 if the type field 365 indicates a domain. If the determination at block 665 is true, then both entries were found and the entries do match, so control continues from block 665 to the beginning of the loop at block 610, as previously described above.

If the determination block 665 is false, then the URL fields 370 in the entries do not match, meaning that the user has attempted to submit a password for the current page that is restricted to another page, or only one entry was found, so control continues from block 665 to block 670 where the controller 170 denies submission of the form. Control then continues from block 670 to block 675 where the logic of FIGS. 6A and 6B returns.

When the loop at block 610 completes, control continues from block 610 to block 630 where the controller 170 performs a loop for each password in the form. So long as a password in the form remains unprocessed, control continues in the loop from block 630 to block 635 where the controller 170 writes an entry to the password list 172 if the password is not already in the password list 172. Control then returns from block 635 to block 630, as previously described above.

Once the loop that starts at block 630 completes, and each password in the form has been processed, then control continues from block 630 to block 640 where the controller 170 submits the form via the network 130. Control then continues to block 699 where the logic of FIGS. 6A and 6B return.

If the determination at block 605 is false, then the form does not contain a password, so control continues from block 605 to block 645 where the controller 170 or the browser 168 submits the form to the server 160. Control then continues to block 698 where the logic of FIG. 6A returns.

In this way, a password may be restricted to a set of pages, where the set may include all pages in a domain or only a single page. Further in this way, reusing a password in a restricted domain is not allowed if the password was previously used outside the restricted domain.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
determining whether a password is restricted to a set of pages; and
if the determining is true, denying submission of the password outside the set of pages.

2. The method of claim 1, wherein the set of pages comprises all pages within a domain.

3. The method of claim 1, wherein the set of pages comprises a single page.

4. The method of claim 1, wherein the determining further comprises:
determining whether one page in the set of pages comprises password restriction control information.

5. The method of claim 1, further comprising:
denying submission of a second password inside the set of pages that was previously used outside the set of pages.

6. An apparatus comprising:
means for determining whether a password is restricted to a set of pages;
means for denying submission of the password outside the set of pages if the determining is true; and
means for allowing submission of the password outside the set of pages if the determining is false.

7. The apparatus of claim 6, wherein the set of pages comprises all pages within a domain.

8. The apparatus of claim 6, wherein the set of pages comprises a single page.

9. The apparatus of claim 6, wherein the means for determining further comprises:
means for determining whether one page in the set of pages comprises password restriction control information.

10. The apparatus of claim 6, wherein the means for determining further comprises:
means for saving a restriction entered from a user interface.

11. A signal-bearing medium encoded with instructions, wherein the instructions when executed comprise:
determining whether a password is restricted to a set of pages, wherein the determining further comprises calculating a key based on the password and saving the key to represent the password;
denying submission of the password outside the set of pages if the determining is true; and
allowing submission of the password outside the set of pages if the determining is false.

12. The signal-bearing medium of claim 11, wherein the set of pages comprises all pages within a domain.

13. The signal-bearing medium of claim 11, wherein the set of pages comprises a single page.

14. The signal-bearing medium of claim 11, wherein the determining further comprises:
determining whether one page in the set of pages comprises password restriction control information.

15. The signal-bearing medium of claim 11, wherein the determining further comprises:
saving a restriction entered from a user interface.

16. A computer system comprising:
a processor; and
memory encoded with instructions, wherein the instructions when executed on the processor comprise:
determining whether a password is restricted to a set of pages, wherein the determining further comprises calculating a key based on the password and saving the key in the memory in lieu of the password,
denying submission of the password outside the set of pages if the determining is true, and
allowing submission of the password outside the set of pages if the determining is false.

17. The computer system of claim 16, wherein the set of pages comprises all pages within a domain.

18. The computer system of claim 16, wherein the set of pages comprises a single page.

19. The computer system of claim 16, wherein the determining further comprises:
determining whether one page in the set of pages comprises password restriction control information.

20. The computer system of claim 16, wherein the determining further comprises:
saving a restriction entered from a user interface.
